(19) United States
(12) Patent Application Publication
(10) Pub. No.: US 2021/0267844 A1
(43) Pub. Date: Sep. 2, 2021

(54) Personal Accessories for Crystal Therapy

(71) Applicant: Elizabeth Grojean, New York, NY (US)

(72) Inventor: Elizabeth Grojean, New York, NY (US)

(21) Appl. No.: 17/188,573

(22) Filed: Mar. 1, 2021

Related U.S. Application Data
(60) Provisional application No. 62/983,682, filed on Mar. 1, 2020.

(51) Int. Cl. A61H 39/00

(52) U.S. Cl. CPC A61H 39/00; A61H 2201/165; A61H 2201/1607

(57) ABSTRACT

The present disclosure provides for personal accessories that may allow for the alignment of crystals with target areas in the body, such as at chakras or reflexology points. Personal accessories may comprise crystal pockets that may hold crystals associated with crystal therapy. In some embodiments, crystal pockets may be located in specific portions of the personal accessories, wherein properly wearing the accessory may align the crystal pockets with target areas. In some aspects, the secure fit and the proper alignment of each wearable item may help crystals properly treat target areas comfortable for longer periods of time.

### CROSS REFERENCE TO RELATED APPLICATION

This application claims priority to and the full benefit of U.S. Provisional Patent Application Ser. No. 62/983,682, filed Mar. 1, 2020, and titled “PERSONAL ACCESSORIES FOR CRYSTAL THERAPY”, the entire contents of which are incorporated in this application by reference.

### BACKGROUND

Concepts of treating the mind and body through chakras and reflexology are common and prominent throughout Eastern cultures and history. Despite this, alternative medicine is commonly overlooked or undervalued in Western cultures. A widening global perspective is increasing the acceptance and use of alternative medicine as a viable solution. Typical alternative medicine treatments include herbal remedies, acupuncture, and crystal therapy. Among those options, crystal therapy is growing in popularity, due in part because it is not an invasive technique, nor does it require a licensed professional.

As crystal therapy has become more prevalent, the solutions for practicing crystal therapy remain simple and traditional with limited innovation. Most commonly, a person may keep crystals in their home for crystal therapy through general proximity. Recently, manufacturers have integrated crystals into household items, such as lighting or decor. Again, these options provide general proximity crystal therapy without a way to target specific areas of the body.

### SUMMARY OF THE DISCLOSURE

What is needed therefore is a way to allow for targeted crystal therapy. Accordingly, the present disclosure provides for personal accessories that may maintain a position of a crystal in proximity to specific target areas, such as chakras or reflexology points. This may allow for an increase in effectiveness and precision with crystal therapy. In some aspects, crystal therapy may be combined with other relaxation features, such as weighted areas, noise-canceling features, or light-canceling.

The present disclosure relates to a wearable crystal therapy mask comprising a plurality of crystals; and a mask configured to cover eyes of a user when worn, wherein the mask comprises a first layer, a crystal pocket containing at least one of the plurality of crystals, wherein the crystal pocket is located on the first layer, an interior flap proximate to the crystal pocket, wherein the interior flap secures the at least one of the plurality of crystals within the crystal pocket, and a securing mechanism configured to secure the mask to the user.

In some aspects, the plurality of crystals may be interchangeable. The crystal pocket may be embedded within the first layer. The mask may further comprise a second layer and the crystal pocket is located between the first layer and the second layer. The crystal pocket may be removable. The first layer and the second layer may form a weighted pocket that holds weighting material. The weight of the weighted pocket may be customizable.

The at least one of the plurality of crystals may be mixed with the weighting material. The at least one of plurality of crystals and weighting material may be further combined with a filler material. The plurality of crystals may comprise crystal particles.

The present disclosure relates to a crystal therapy cover comprising: a plurality of crystals; at least one crystal pocket configured to hold at least a portion of the plurality of crystals; at least one weighted portion configured to hold weighted material; a cover portion comprising a first layer and a second layer; and filler material located between the first layer and the second layer, wherein the filler material is configured to provide shape to the cover portion.

The plurality of crystals may comprise a plurality of types of crystals. The first layer and the second layer comprise a series of filler pockets, wherein each of the series of filler pockets comprises a pocket segment with filler material. At least a portion of the series of filler pockets may comprise mixed pockets comprising filler material and one or both at least one crystal pocket and at least one weighted portion. At least a filler portion of series of filler pockets may contain filler material, and wherein the mixed pockets are located centrally on the crystal therapy cover and the filler portion is located along a perimeter of the crystal therapy cover.

The present disclosure relates to a crystal therapy cover comprising: a plurality of crystals; a plurality of crystal pockets, wherein each of the plurality of crystal pockets is configured to hold at least a portion of the plurality of crystals; a plurality of weighted pockets configured to hold weighted material; a cover portion comprising a first layer and a second layer; and filler material located between the first layer and the second layer, wherein the filler material is configured to provide shape to the cover portion.

At least a portion of the plurality of crystal pockets may be located within a portion of the plurality of weighted pockets, wherein the at least a portion of the plurality of crystals and the weighted material are separate. The plurality of crystal pockets align with chakras of a user when the cover is used. At least a portion of the plurality of crystal pockets and a portion of the plurality of weighted pockets are combined, wherein the at least a portion of the plurality of crystals and the weighted material are mixed. The at least a portion of the plurality of crystals and the weighted material may be further mixed with filler.

### BRIEF DESCRIPTION OF THE DRAWINGS

The accompanying drawings that are incorporated in and constitute a part of this specification illustrate several embodiments of the disclosure and, together with the description, serve to explain the principles of the disclosure:

FIG. 1 illustrates exemplary target areas for crystal therapy along a body, according to some embodiments of the present disclosure.

FIG. 2 illustrates an exemplary mask with crystal pocket, according to some embodiments of the present disclosure.

FIG. 3 illustrates an exemplary mask with crystal pocket, according to some embodiments of the present disclosure.

FIG. 4A illustrates an exemplary mask with crystal pocket, according to some embodiments of the present disclosure.

FIG. 4B illustrates an exemplary mask with extended crystal pocket, according to some embodiments of the present disclosure.

FIG. 5 illustrates a crystal pocket with exemplary crystal securing mechanism for a mask, according to some embodiments of the present disclosure.

FIG. 6 illustrates a mask with crystal pocket and exemplary crystal securing mechanism, according to some embodiments of the present disclosure.

FIG. 7A illustrates an unfolded view of a full mask with collar and crystal pockets, according to some embodiments of the present disclosure.

FIG. 7B illustrates a front view of a user wearing a full mask with collar and crystal pockets, according to some embodiments of the present disclosure.

FIG. 7C illustrates a back view of a user wearing a full mask with collar and crystal pockets, according to some embodiments of the present disclosure.

FIG. 8A illustrates a side view of an exemplary pair of socks with crystal pockets, according to some embodiments of the present disclosure.

FIG. 8B illustrates a bottom view of an exemplary pair of socks with crystal pockets, according to some embodiments of the present disclosure.

FIG. 9A illustrates a top view of an exemplary fingerless glove with crystal pockets, according to some embodiments of the present disclosure.

FIG. 9B illustrates a bottom view of an exemplary fingerless glove with crystal pockets, according to some embodiments of the present disclosure.

FIG. 10A illustrates a top view of an exemplary glove with crystal pockets, according to some embodiments of the present disclosure.

FIG. 10B illustrates a bottom view of an exemplary glove with crystal pockets, according to some embodiments of the present disclosure.

FIG. 11A illustrates an exemplary blanket and mask with crystal pockets, according to some embodiments of the present disclosure.

FIG. 11B illustrates a transparent view of an exemplary blanket and mask with crystal pockets, according to some embodiments of the present disclosure.

FIG. 12 illustrates an exemplary cover for children, according to some embodiments of the present disclosure.

FIG. 13 illustrates an exemplary weighted cover, according to some embodiments of the present disclosure.

FIG. 14 illustrates an exemplary cover comprising a plurality of pockets and securing mechanisms, according to some embodiments of the present disclosure.

FIG. 15 illustrates an exemplary crystal therapy device comprising a plurality of materials, according to some embodiments of the present disclosure.

FIG. 16A illustrates an exemplary pillow comprising a plurality of pockets, according to some embodiments of the present disclosure.

FIG. 16B illustrates an exemplary pillow comprising a plurality of materials, according to some embodiments of the present disclosure.

FIG. 17 illustrates an exemplary pillow comprising a plurality of pockets, according to some embodiments of the present disclosure.

FIG. 18A illustrates a wearable exemplary robe comprising a plurality of pockets and materials, according to some embodiments of the present disclosure.

FIG. 18B illustrates an exemplary robe comprising a plurality of pockets and securing mechanisms, according to some embodiments of the present disclosure.

FIG. 19A illustrates an exemplary pet vest comprising a plurality of pockets, according to some embodiments of the present disclosure.

FIG. 19B illustrates an exemplary cover, according to some embodiments of the present disclosure.

FIG. 19C illustrates an exemplary cover comprising a plurality of material, according to some embodiments of the present disclosure.

FIG. 20A illustrates a wearable exemplary collar, according to some embodiments of the present disclosure.

FIG. 20B illustrates a wearable exemplary collar, according to some embodiments of the present disclosure.

FIG. 20C illustrates a wearable exemplary collar, according to some embodiments of the present disclosure.

FIG. 21A illustrates an exemplary pet bed comprising a plurality of pockets, according to some embodiments of the present disclosure.

FIG. 21B illustrates an exemplary pet bed comprising a plurality of material, according to some embodiments of the present disclosure.

FIG. 22A illustrates an exemplary pet bed comprising a plurality of pockets, according to some embodiments of the present disclosure.

FIG. 22B illustrates an exemplary pet bed comprising a plurality of pockets and material, according to some embodiments of the present disclosure.

### DETAILED DESCRIPTION

The present disclosure provides generally for different variations of wearable technology that relate to crystal therapy, particularly in conjunction with concepts of chakras and reflexology. According to the present disclosure, crystal therapy may be integrated with different types of wearable items, including blankets and clothing, such as masks, gloves, and socks, as non-limiting examples. In some embodiments, wearables may be used during times of relaxation, such as while on a couch or in bed. In some aspects, the wearables may be used during activities, such as driving, working, and walking. In some implementations, crystals may be integrated into crystal pockets. In some aspects, the crystals may comprise a solid segment of crystal or may comprise a mix of crystal and softer medium to allow for increased comfort.

In some embodiments, the crystal pockets may be located proximate to the chakras of the body or to reflexology points. In some implementations, the crystal pockets may expose those target therapy points to specific crystals. For example, the blanket may be used to keep each crystal near the chakra of each section of the body while the body may be at rest. In some embodiments, these devices may be used to cover more area in general than traditional chakra technology.

In some aspects, multiple crystals may be placed within a crystal pocket, which may allow for dynamic treatment of chakras and reflexology points. For example, crystals may comprise flat disks that may be stacked into a crystal pocket. As another example, a mix of crystal pieces may be combined with a cohesive medium that may be inserted into a crystal pocket. In some embodiments, crystal pockets may be uniquely designed for different chakras and reflexology points, such as different sizes and shapes.

In some implementations, the masks may comprise a range of shapes and sizes, which may accommodate for a range of functions and user sizes. In some aspects, a mask may have other features as well, which may complement the crystal therapy, such as noise canceling features, head phone features, heating or cooling features, weighted features, or massage features, as non-limiting examples. For example, a mask may comprise crystal pockets and may also include different features such as noise cancelling technology, speakers for music, or a screen for television, as non-limiting examples.

In some embodiments, a mask may comprise a clasping system to secure the mask to the user, and the clasping system may depend on the mask. For example, a bulkier mask may have a stronger magnetic clasping system; or a smaller mask may have a more lightweight clasping system involving hook and loop.

In some implementations, wearable items may comprise crystal pockets, wherein wearable items may include, but are not limited to, socks, gloves, or blankets. In some aspects, crystal pockets may be varied in size, which may accommodate for different target points, and these pockets may have the capability of adding weight as well. For example, specific pockets may be designed to hold sand, water, or any other substance that may change the weight of the item.

In the following sections, detailed descriptions of examples and methods of the disclosure will be given. The description of both preferred and alternative examples, though thorough, are exemplary only, and it is understood to those skilled in the art that variations, modifications, and alterations may be apparent. It is therefore to be understood that the examples do not limit the broadness of the aspects of the underlying disclosure as defined by the claims.

### Glossary

Crystal Therapy: as used herein refers to mental and physical therapy through use of crystals. Crystal therapy comprises an alternative medical technique where crystals may be used to draw out negative energies, which may cure ailment, protect against disease, and increase overall health and mental wellness.

Crystal Pocket: as used herein refers to a portion of a personal accessory that may accept a crystal. In some aspects, a crystal pocket may allow for the insertion and removal of crystals. In some embodiments, a crystal pocket may be permanently closed once a crystal or crystals are inserted.

Crystal: as used herein refers to an insertable object comprising a gemstone, mineral, or stone that may comprise therapeutic properties. In some aspects, the crystal may be a solid crystal, such as in disk form, raw form, or polished form, as non-limiting examples. In some embodiments, crystal pieces or powders may be combined with another medium that may contain the crystal, which may be inserted into a crystal pocket.

Target Area: as used herein refers to a target for crystal therapy. In some aspects, the target area may comprise a chakra. In some embodiments, the target area may comprise a reflexology point.

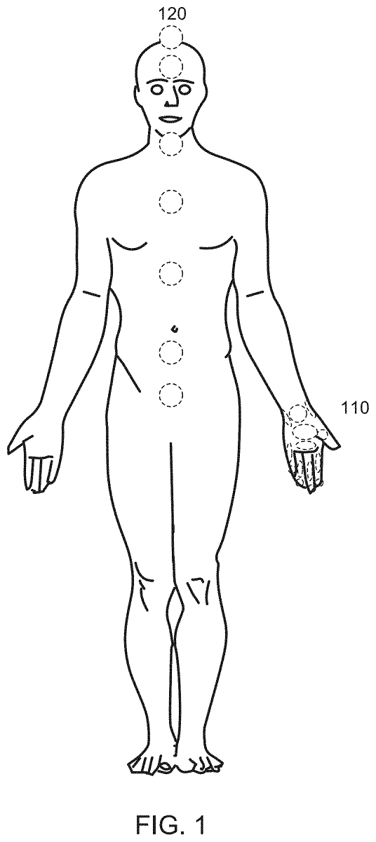

Referring now to FIG. 1, exemplary target areas for crystal therapy along a body is illustrated. In some aspects, target areas may comprise reflexology points 110 and chakras 120, which may be located throughout the body. In some embodiments, each location may be unique throughout the body as shown on the chart. For example, each hand may comprise multiple reflexology points 110. In some implementations, chakras 120 may be located along the center of a body.

In some implementations, different crystals may treat different target areas. In some embodiments, effective crystal therapy may differ between users, such as based on reason for therapy or the target area, as non-limiting examples. A crystal may treat one person differently than another on the same target area. For example, an amethyst crystal may treat one persons' target area better than a Blue Lace Agate would treat another persons' target area.

In some embodiments, different crystals may treat different chakras 120. For example, a Dalmatian Jasper may be more effective for one persons' solar plexus (third chakra 120) than a Tourmilated Quartz, which may be effective for the solar plexus of a different individual. In some aspects, chakras 120 may receive different crystal therapy than reflexology points 110. For example, the crown (seventh chakra 120) may be located at the top of the head and have a different effect than that of the reflection point 110 located on the hand.

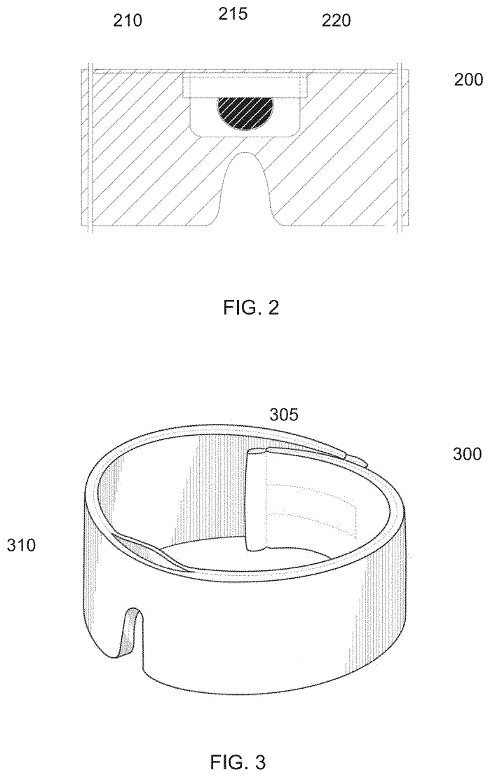

Referring now to FIG. 2, an exemplary mask 200 with crystal pocket is illustrated. In some aspects, a mask 200 may comprise a crystal pocket 210 on the inner side of the mask 200 located directly in line with the third eye. In some implementations, the crystal pocket 210 may house different types of crystals 220 used for reflexology. For example, an amethyst crystal 220 may be placed into the pocket 210 used for calming or soothing. In some embodiments, a crystal pocket 210 may be large enough to house different types or sizes of crystals 220. In some implementations, a plurality of crystals 220 may be interchangeable.

In some implementations, the interior flap 215 may be used to protect the crystal 220 inside the crystal pocket 210. In some aspects, the interior flap 215 may fold over on top of the crystal pocket 210. In some embodiments, an interior flap 215 may snap onto the side of the crystal pocket 210. In some aspects, the interior flap 215 may comprise a hook and loop backing.

In some embodiments, a mask 200 may have comprise a protective material over the eyes. In some implementations, the protective material may be tinted for a more relaxing feel. In some aspects, the protective material may comprise a softer material for increased comfort. In some implementations, the protective material may comprise blue light protective film to protect the eyes from looking at a screen for a long period of time. In some embodiments, the protective material may comprise a naturally cool material, which may provide a cooling treatment for the eyes.

Referring now to FIG. 3, an exemplary mask 300 with crystal pocket 310 is illustrated. In some embodiments, a mask 300 may comprise a securing mechanism 305 that may secure the mask 300 to the user. In some aspects, the securing mechanism 305 may comprise magnets when being clasped together. For example, magnets may be located on each side of the securing mechanism 305, and when clasped together may magnetize and stay clasped when in use. In some implementations, a switch in which the user may toggle the magnetism on and off when the mask 300 is in use or not.

In some embodiments, the securing mechanism 305 may be comprise a snap, and the user may snap the mask 300 on and off. For example, there may exist a row of snapping mechanisms in which each side of the mask 300 connects to the other. In some aspects, columns or arrays of snapping mechanisms may provide a strong connection. In some implementations, snap shape, size, and configuration may depend on the mask 300. For example, a mask with a single crystal pocket that covers the eyes and the third eye may have different securing needs than a larger mask comprising crystal pockets at the crown, third eye, and throat chakra.

In some aspects, a hook and look securing mechanism 305 in which the mask 300 may allow for quick attachment and detachment. In some embodiments, a patch of hook and loop material for a larger or heavier mask 300 may comprise more area than that of a smaller mask 300. For example, a smaller mask 300 may have a small column of hook and loop securing mechanism 305 whereas a larger mask 300 may have several rows or columns.

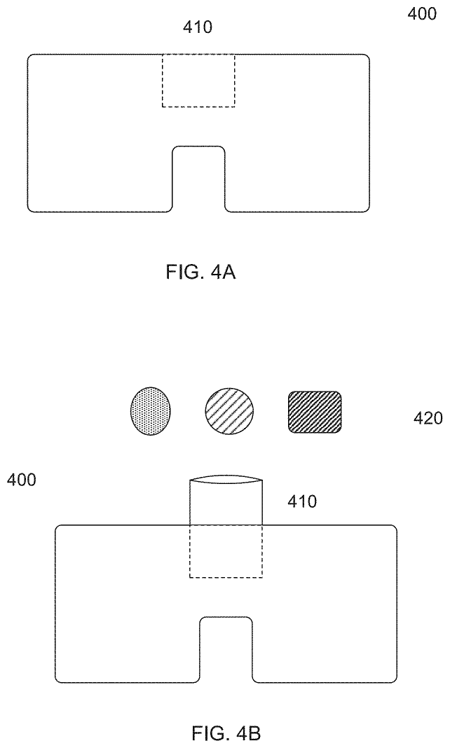

Referring now to FIGS. 4A-4B, an exemplary mask 400 with crystal pocket 410 is illustrated. In some implementations, the pocket 410 may be large enough to hold different types and sizes of crystals 420. For example, multiple smaller crystals 420 may fit in the pocket 410, or a larger crystal 420 may fit securely in the pocket 410. In some embodiments, the pocket 410 may have a securing mechanism inside that may adjust to different sizes of crystals, preventing them from falling out or sliding around.

In some implementations, a mask 400 may comprise adjustable compartments within the crystal pocket 410 that may house multiple crystals 420 in a secure and organized manner. For example, the compartment may adjust for a smaller crystal 420 in one compartment and a larger crystal 420 in a separate compartment. In some embodiments, the compartment may adjust based on the number of crystals 420 and size of each needed to be placed into the pocket 410. In some aspects, the crystal pocket 410 may be turned out for easy removal of the crystal 420.

In some embodiments, crystals 420 may be stacked on another within a crystal pocket 410. For example, flat crystals 420 may be stacked on each other inside the compartment safely and securely, limiting the risk of the crystals 420 falling out of the crystal pocket 410. In some aspects, the compartment may allow for proper alignment of each crystal 420 to the different chakras located in the head area. For example, the compartment may properly align a crystal 420 directly over the third eye chakra in between the eyebrows for proper treatment and best results.

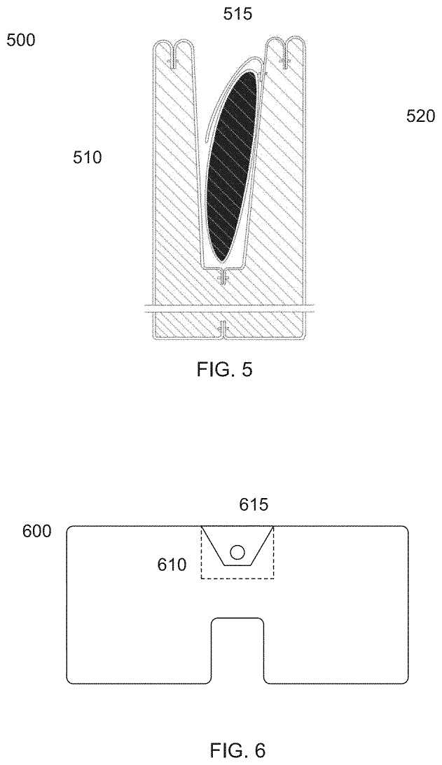

Referring now to FIG. 5, a crystal pocket 510 with an exemplary crystal securing mechanism 515 for a mask 500 is illustrated. In some implementations, a securing mechanism 515 may be adjusted as previously stated to secure one or more crystals 520 inside the pocket 510. In some aspects, the securing mechanism 515 may be adjusted for the size and shape of an individual crystal or crystals 520.

In some embodiments, the securing mechanism 515 may be adjusted using an air pump system, wherein the air pump system may control the space in the crystal pocket 510. In some implementations, the user may manually adjust the space. In some aspects, the securing mechanism 515 may have an automated air pump system that may sense the size and weight of the crystals 520 inside the pocket 510. For example, there may be two different sized crystals 520 inside the pocket 510 and the securing mechanism 515 may sense how much air needs to be pumped into the pocket 510 to safely secure the crystals 520 in place.

In some implementations, a securing mechanism 515 may be removable. For example, the original style pocket may be too larger for a smaller crystal 520, and separate components may come with the mask 500 to be placed inside the pocket 510 to properly secure each individual crystal 520 inside. In some embodiments, a purse-like securing mechanism 515 may allow for a secure fit for crystals 520.

For example, a crystal pocket 510 may comprise a snap or hook system near the top of the opening, which may allow for a crystal 520 to be placed inside and then locked inside the crystal pocket 510. In some embodiments, a magnetizing system within the crystal pocket 510 may allow for a crystal or crystals 520 to be closed within the crystal pocket 510 by pushing the crystal pocket 510 sides together.

Referring now to FIG. 6, a mask 600 with crystal pocket 610 and exemplary crystal securing mechanism 615 is illustrated. In some implementations, a crystal pocket 610 may be an envelope-style pocket that may limit the risk of the crystals falling out. A flap on a crystal pocket 610 may fold over and secure the crystals and limit shifting within the crystal pocket 610. In some embodiments, the pocket 610 may hold a weighted material such as water, sand, or a solid, as non-limiting examples. For example, the crystal pocket 610 may hold crystals and sand at the same time to enable the mask 600 to act as a weight while also helping with crystal therapy.

In some aspects, a snap or button on the pocket 610 may allow for the securing mechanism 615 to be closed and sealed. In some embodiments, a securing mechanism 615 may fold over and secure the crystals inside the crystal pocket 610. In some implementations, an adjustable snap system may allow for a more secure fit based on different sizes and variations of crystals inside the pocket 610.

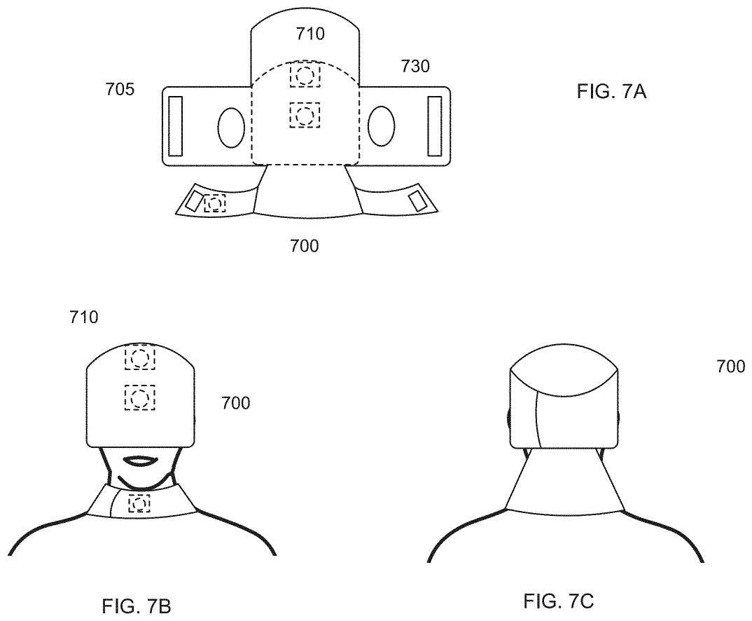

Referring now to FIG. 7A, an unfolded view of a full mask 700 with collar and crystal pockets 710 is illustrated. Referring now to FIG. 7B, a front view of a user wearing a full mask 700 with collar and crystal pockets 710 is illustrated. Referring now to FIG. 7C, a back view of a user wearing a full mask 700 with collar and crystal pockets 710 is illustrated. In some embodiments, a large mask 700 may be used for personal or private treatment at home and may not be as convenient for travel as a less extensive mask.

In some aspects, a mask 700 may comprise a securing mechanism 705 that may secure the mask 700 to a user. In some embodiments, a strong securing mechanism 705 may allow for increased stability of the crystal pockets 710 over target areas. In some implementations, a mask 700 may be bulkier than a standard sleep mask and may require a more secure system to keep the mask 700 stable and secure on the head. In some aspects, a securing mechanism 705 may comprise a magnetic system.

In some embodiments, a securing mechanism 705 may comprise a hook and loop material. For example, one or more arrays of hook and loop material may allow for a range of sizes and fits of the mask 700 for different users, limiting movement of the mask 700 on the head. In some aspects, a securing mechanism 705 may comprise a series of slits and buttons. For example, the slits may fit around the buttons securely, keeping the securing mechanism 705 intact and leaving the mask 700 secure on the head.

In some embodiments, a securing mechanism 705 may comprise a strap tightening system. In some aspects, a strap may extend over the chin or neck area. For example, this strapping system may be similar to that of a traditional motorcycle or bicycle helmet in order to properly fit onto each unique head. In some implementations, a mask 700 may comprise a neck securing mechanism for the collar, which may add stability to the collar portion.

In some aspects, a mask 700 may comprise a central crystal pocket 710 or multiple crystal pockets, which may allow for secure placement of crystals within the crystal pocket 710. In some implementations, a mask 700 may comprise a primary crystal pocket 710 for each target area. In some embodiments, multiple crystal pockets 710 may allow for more precise crystal therapy for target areas. For example, an amethyst crystal may be put into one pocket 710, while a howlite may be put into another. Combinations may allow for diverse crystal therapy. In some implementations, a plurality of crystals may be interchangeable.

In some embodiments, a crystal pocket 710 may be designed to specifically house crystals, while another pocket may be used specifically for weighted objects such as water, sand or any other non-limiting factors. In some aspects, crystal pockets 710 may hold crystals and weighted material. For example, crystals may be mixed into a sand material, and inserting the mix into a crystal pocket 710 may add weight and crystal therapy.

In some embodiments, a mask 700 may comprise an ear feature 730 built into the interior of the mask 700. In some aspects, an ear feature 730 may be a noise canceling system, which may allow for quiet relaxation during the crystal therapy. In some implementations, an ear feature 730 may comprise audio speakers, which may allow a user to listen to relaxing media during the crystal therapy. For example, a user may listen to calming music, affirmations, breathing exercises, white noise, or calming sounds. In some aspects, an ear feature 730 may comprise a recess that may accept the ears, which may increase the comfort of the mask 700.

In some aspects, an ear feature may comprise special padding or liner used for a noise cancelling system or added comfort. In some embodiments, speakers may play audio through the interior of the mask 700 as the ear feature. In some aspects, the speakers may have Bluetooth capability, which may allow for syncing with various different Bluetooth capable audio devices. For example, the speakers may have the ability to connect to smart phones and other smart devices, which may allow a user to listen to audio or answer phone calls. In some implementations, a mask 700 may have built-in speakers allowing a user to access their telephone while still getting proper crystal therapy treatment from the mask 700. In some embodiments, a mask 700 may comprise comfortable padding for maximum relaxation when in use. For example, the padding may allow a user to lay on their side during crystal therapy treatment.

In some implementations, the mask 700 may comprise electronic components that activate upon insert of a crystal into a crystal pocket 710. For example, the crystal pocket 710 may comprise a small light that may activate upon insertion of a crystal and illuminate the crystal within the crystal pocket 710 via a transparent portion of the crystal pocket 710. In some aspects, the mask 700 may comprise haptic feedback. As an example, the mask 700 may vibrate as crystal are inserted into the crystal pockets 710 to validate correct insertion. In some embodiments, the mask 700 may vibrate at a plurality of frequencies to foster relaxation.

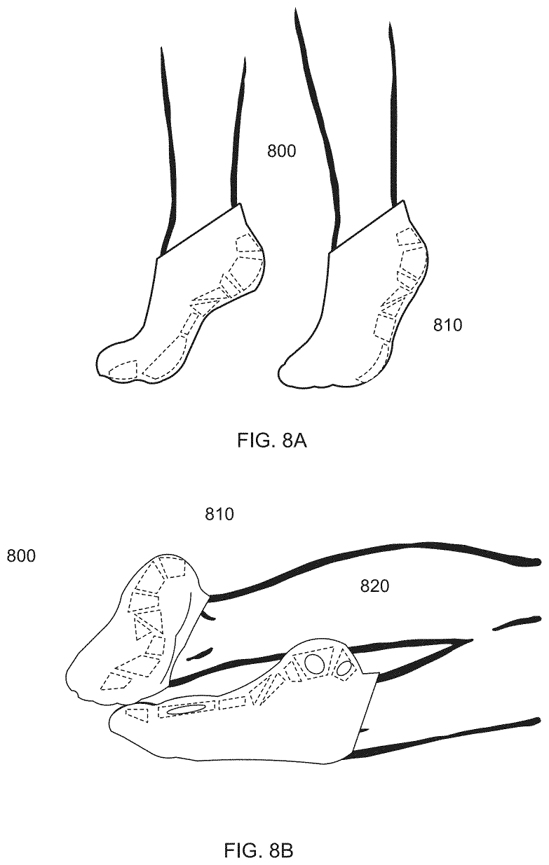

Referring now to FIG. 8A, a side view of an exemplary pair of socks 800 with crystal pockets 810 is illustrated. Referring now to FIG. 8B, a bottom view of an exemplary pair of socks 800 with crystal pockets 810 is illustrated. In some aspects, crystal pockets 810 in socks 800 may allow for crystal therapy for target areas in the foot. For example, the socks 800 may have pockets 810 included on the sides and the top of the socks 800 so they can be worn during crystal therapy. In some embodiments, crystals 820 may be thin enough to fit into the crystal pockets 810 of the socks 800 without causing discomfort to the user when walking or being used with shoes on.

In some implementations, crystal pockets 810 may be located on the bottom of the socks 800. In some embodiments, socks 800 may be worn during relaxation or while in motion. In some aspects, the crystals 820 or crystal construction may be based on the intended use. For example, when the user is sleeping or not planning to go out or walk around, crystals 820 may comprise solid or rigid this variation of the socks 800 may be used for crystal therapy when the user is immobile. In some aspects, crystal pockets 810 may be located throughout the sock 800.

In some embodiments, crystal pockets 810 may be located at a specific target area, such as the heel to address issues with the lower back, hip, knee, ankle, and foot. In some implementations, crystal pockets 810 may allow for treatment of multiple target areas. For example, a crystal pocket 810 may be located in the arch of the foot, which may encompass four or more reflexology points. A crystal pocket 810 may be located at each toe. For example, a crystal pocket 810 on the big toe of the socks 800 treat the head and brain area in crystal therapy. In some aspects, a long crystal pocket 810 may extend over multiple toes, allowing for therapy for multiple target areas.

In some implementations, different sizes of socks 800 may treat different areas for different users. For example, a user may want to treat target areas on their ankle or lower leg, and the sock (not shown) may comprise a knee-high sock. As another example, a small size sock may comprise fewer crystal pockets 810 than a larger size because of inherent area limitations.

In some aspects, calf length socks 800 may comprise crystal pockets 810 that go up the leg as well for crystal therapy throughout the leg and foot of the user. For example, crystal pockets 810 may be located on the base of the foot and more crystal pockets 810 along the calf. In some embodiments, full length socks 800 may extend up the entire leg. In some implementations, crystal pockets 810 may be located along the leg at target areas. For example, a full-length pair of socks 800 may be customized with pockets 810 for the user to target specific areas of their leg using crystal therapy. In some respects, the socks 800 may be fully customized with pockets 810 in exact areas upon the user request. For example, a sock 800 may be customized to treat issues with digestion, and the crystal pockets 810 may located at target areas that relate to organs associated with digestion.

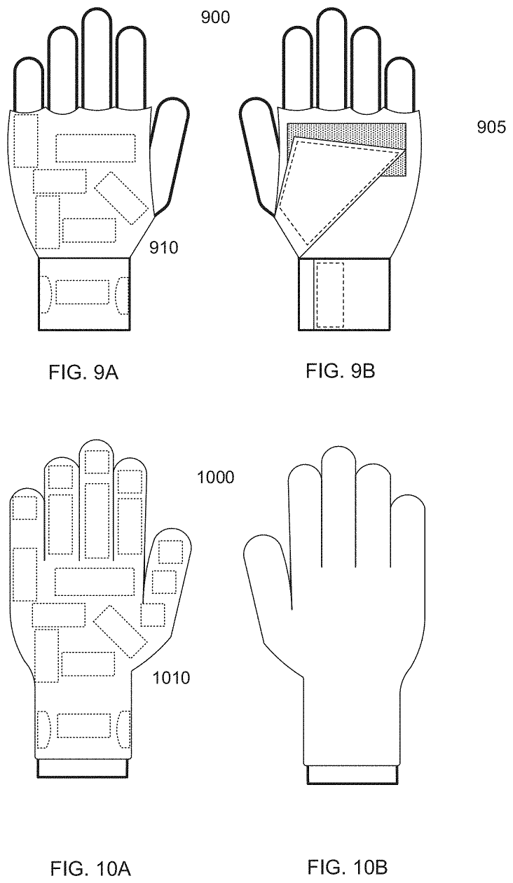

Referring now to FIG. 9A, a top view of an exemplary fingerless glove 900 with crystal pockets 910 is illustrated. Referring now to FIG. 9B, a bottom view of an exemplary fingerless glove 900 with crystal pockets 910. In some embodiments, a glove 900 may comprise crystal pockets 910 for crystal therapy. In some aspects, a glove 900 may come without finger covers. In some implementations, a glove 900 may allow crystal therapy to focus on the reflexology points on the palm and top of the hand, such as those target areas that may relate to a user's kidney, thyroid, stomach, shoulder, or the throat, as non-limiting examples. In some embodiments, a glove 900 may comprise a wrist brace portion that wraps around a wrist. In some aspects, the wrist wrap portion may comprise crystal pockets 910, which may allow for crystal therapy for target areas in the wrist.

In some embodiments, a glove 900 may comprise a securing mechanism 905 that may secure the glove 900 over the users' hand. In some aspects, the securing mechanism 905 may comprise a hook and loop strap, which may allow for a custom fit. In some implementations, a strapping system in which the user may adjust the fit of the glove by loosening or tightening a strap down. For example, the strapping system may be pulled tighter, and then a buckle may lock the strapping system in place keeping the preferred fit of the glove 900.

In some aspects, the securing mechanism 905 may be a belt-like strap that is adjustable to specific fitted sizes. For example, belt-like strap may fit into premanufactured holes on the glove 900. In some embodiments, the securing mechanism 905 may be a magnetic, and the magnetization may be strong enough to keep the glove 900 secure around the hand. For example, magnetic strips may be located around the wrist area.

In some aspects, a glove 900 may be customizable, wherein crystal pockets 910 may be selected by a use, allowing for custom crystal therapy. For example, the pockets 910 may be placed in specific locations to treat the users' weakest areas or areas of pain. If the user has liver issues, they may request a pocket on the left side of their hand. As another example, the crystal pockets 910 may only be located on the underside of the glove 900 as shown, and the securing mechanism 905 may occupy the upper side of the glove 900.

Referring now to FIG. 10A, a top view of an exemplary glove 1000 with crystal pockets 1010 is illustrated. Referring now to FIG. 10B, a bottom view of an exemplary glove 1000 with crystal pockets 1010 is illustrated. In some aspects, a glove 1000 may comprise fingers with crystal pockets 1010. In some embodiments, crystal pockets 1010 may be located on the finger portion of the glove 1000. In some embodiments, a glove 1000 may comprise crystal pockets in the finger area.

In some aspects, a glove 1000 may slide on like a traditional glove. A glove 1000 may comprise a stretchable material that may fit over a range of hand sizes. In some embodiments, a glove 1000 may comprise a standard glove material, such as wool or cotton. In some implementations, a glove 1000 may comprise a snug fit, such as with a neoprene or partial silicone material. In some aspects, the crystal pockets 1010 may limit slipping of the crystals, such as through a securing mechanism or non-slip material or texture. In some implementations, when the crystal pockets 1010 are empty, the glove 1000 may be used as a traditional glove 1000 to keep hands warm.

In some aspects, crystal pockets 1010 may contain a range of crystals and crystal materials. For example, the glove 1000 may comprise large crystal pockets 1010 that may accept solid crystal pieces, and smaller crystal pockets 1010 may accept crystal composites, such as sand, beads, or mixed pieces. In other embodiments, the glove 1000 may comprise a surface area that may cover multiple target areas, which may allow for multiple crystal pockets 1010.

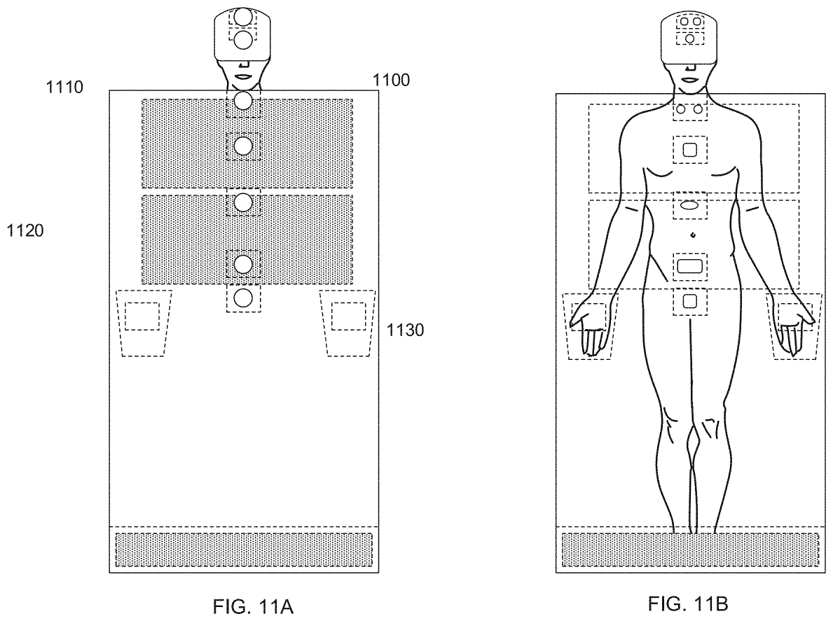

Referring now to FIG. 11A, an exemplary blanket 1100 and mask with crystal pockets 1110 is illustrated. Referring now to FIG. 11B, a transparent view of an exemplary blanket 1100 and mask with crystal pockets 1110 is illustrated. In some aspects, a blanket 1100 may comprise multiple crystal pockets 1110 that may align with each individual chakra on the body. For example, a blanket 1100 may comprise crystal pockets 1110 that align with the chakra over the throat (Vishuddha) and the solar plexus chakra (Manipura). In some embodiments, a blanket 1100 may comprise one crystal pocket 1010 for each chakra. In some implementations, a blanket 1100 may be customizable, wherein a user may select the locations and number of crystal pockets 1110.

In some embodiments, a blanket and mask 1100 may comprise at least one crystal pockets 1110 configured to hold at least a portion of the plurality of crystals. In some aspects, the blanket and mask 1100 may comprise a plurality of crystal pockets 1110, wherein each of the plurality of crystal pockets 1110 is configured to hold at least a portion of the plurality of crystals. In some implementations, a blanket and mask 1100 may comprise at least one weighted portion configured to hold weighted material. In some aspects, a blanket and mask 1100 may comprise a cover portion comprising a first layer and a second layer. In some implementations, the blanket and mask 1100 may comprise filler material located between the first layer and the second layer, wherein the filler material is configured to provide shape to the cover portion.

In some embodiments, a blanket 1100 may comprise weighted pockets 1120 that may accept weighted objects. In some aspects, these weighted pockets 1120 may be pre-weighted for added comfort and to limit their movement while asleep for the best crystal therapy treatment. In some implementations, weighted pockets 1120 may receive a range of objects, which may allow for a range of treatments and weights. For example, a blanket 1100 may comprise multiple weighted pockets 1120, and one may be used for a bead and crystal mix and another may be used for a weighted object to help keep a specific side or section of the blanket 1100 more secure.

In some aspects, weighted pockets 1120 may be heated or cooled for an added feature of treatment or relaxation or more effective crystal therapy treatment. In some embodiments, multiple weighted pockets 1120 may allow for controlled and targeted weighting and temperature treatment, which may allow for control of temperature and weight for the entirety of the blanket 1100 or certain sections of the blanket 1100. For example, weighted temperature packs may be inserted into a section of the blanket 1100. In some embodiments, different size weighted pockets 1120 may target different size areas of the body. In some implementations, sand or water may be inserted into weighted pockets 1120 to change the weight of the blanket 1100. For example, a material may retain a predefined temperature and may provide weight.

Though illustrated as a series of weighted pockets 1120, a blanket 1100 may comprise a large pocket that may be filled with crystals, wherein the large pocket may comprise a surface area similar to the entire blanket 1100. This may allow for crystals to be located proximate to target areas regardless of how the user places the blanket 1100 over them. In some aspects, a blanket 1100 may be quilted, wherein each quilted pocket may comprise one or more crystals, such as in ground, crushed, or pebbled form. Quilted pockets may limit the risk of the filling collecting in a corner of blanket and allow for an even distribution of filling throughout the blanket 1100.

In some embodiments, a blanket 1100 may comprise alignment pockets 1130 for hands and feet that may help a user to properly align crystal pockets with the target areas, such as reflexology points or chakras. In some respects, alignment pockets 1130 may be adjusted to a certain sleeping position for a more comfortable feel. For example, the alignment pockets 1130 may be adjusted to different foot positions at the end of the blanket 1100, and the hand positions may be changed to different positions. This may allow for a more comfortable crystal therapy treatment for the user as well.

In some implementations, different sections of the blanket 1100 may comprise pads that may be heated or cooled. For example, a pad in the chest area of the blanket 1100 may be manually controlled by the user. In some aspects, the temperature of the blanket 1100 or the section where the crystal therapy is happening to a specific chakra may have a more positive affect than a room temperature treatment. In some embodiments, the alignment pockets 1130 may comprise crystal pockets 1130 as well. For example, the alignment pockets 1130 may hold crystals, which may allow the blanket 1100 to be properly aligned and still continue to use crystal therapy in those target areas.

In some aspects, the blanket 1100 may comprise a foot crystal pocket 1140. A foot crystal pocket 1140 may accept free crystals, such as in their whole form. In some embodiments, a foot crystal pocket 1140 may accept a crystal mix, such as a mix of crushed or pebbled crystals. This may allow for a crystal filling that may be more comfortable than a collection of larger crystals. In some implementations, the crystal mix may comprise a noticeable weight, which may add the comfort of heaviness to the base of the blanket 1100.

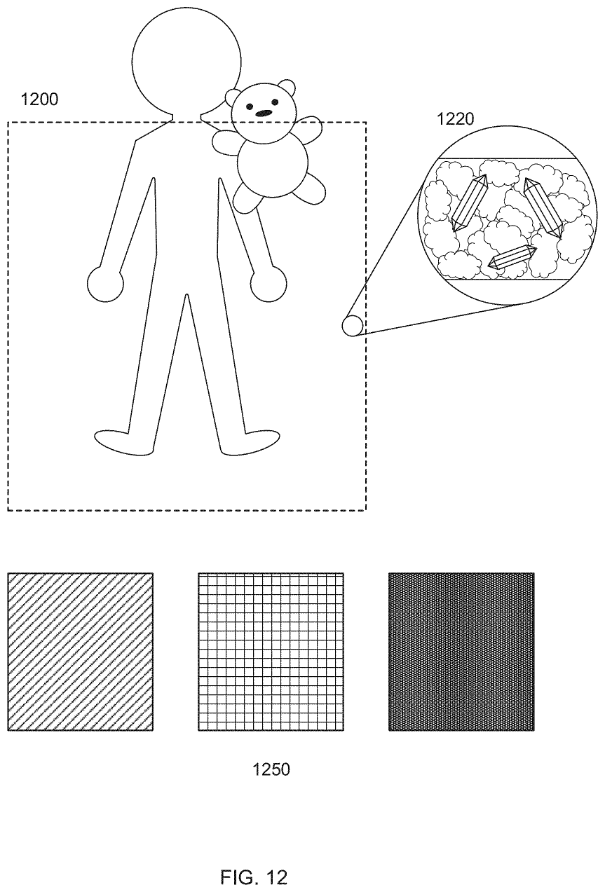

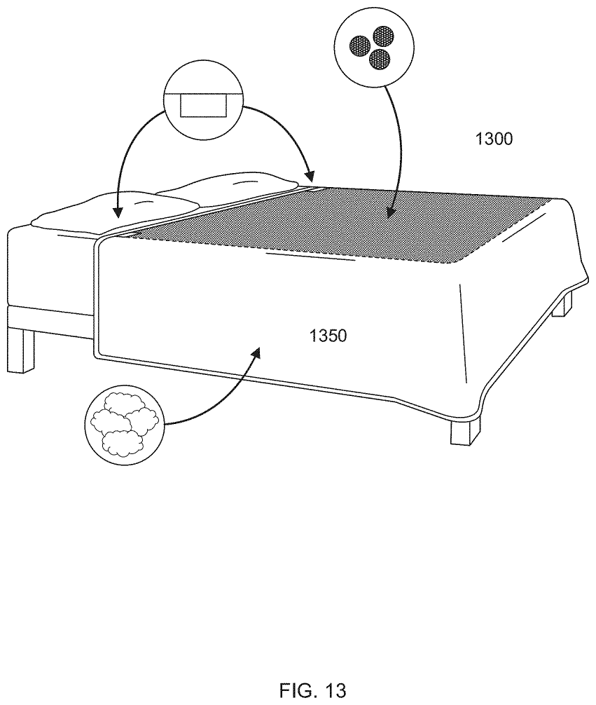

Referring now to FIG. 12, an exemplary blanket 1200 is illustrated. In some implementations, the blanket 1200 may be draped over a user and comprise a plurality of crystals 1220 within a plurality of material 1250. In some aspects, the blanket 1200 may act as a blanket covering a user and using the power of the crystals 1220 for a therapeutic reason. In some embodiments, the blanket 1200 may come in different sizes. For example, a blanket version may be created for a child, a version may be created for young adults, and a version for larger users may be created as non-limiting examples.

In some implementations, the crystals 1220 may be permanently placed throughout the entirety of the blanket 1200. In some aspects, the crystals 1220 may be placed in different parts of the blanket 1200 depending on the material 1250 used. For example, if a thinner material 1250 is being used then the crystals 1220 may be spread out more throughout the blanket 1200, whereas a thicker material 1250 may allow for more crystals to be placed throughout. In some embodiments, the blanket 1200 may comprise more than one material 1250 at one time. In some aspects, a cover 1200 may comprise a quilted pattern to confine crystals 1220 to predefined pockets, allowing for known distribution of the crystals 1220 throughout the cover 1200.

In some embodiments, a blanket 1200 may comprise at least one crystal pockets configured to hold at least a portion of the plurality of crystals. In some implementations, a blanket 1200 may comprise at least one weighted portion configured to hold weighted material 1250. In some aspects, a blanket 1200 may comprise a cover portion comprising a first layer and a second layer. In some implementations, the blanket 1200 may comprise filler material 1250 located between the first layer and the second layer, wherein the filler material 1250 is configured to provide shape to the cover portion.

In some embodiments, the blanket 1200 may be weighted. In some implementations, the blanket 1200 may be colored. In some aspects, the coloring may be a vegetable dye applied to the blanket 1200. For example, a child's weighted blanket may be colored a soft blue using vegetable dye.

Referring now to FIG. 13, an exemplary weighted cover 1300 that may be used as a therapeutic blanket is illustrated. In some implementations, the cover 1300 may have a weighted section along the topside of the device. In some embodiments, the weighting may consist of glass microbeads, sand, fibers, and other non-limiting examples. In some aspects, a cover 1300 may comprise a series of quilted pockets that may allow for even and known distribution of weight throughout the cover 1300. In some embodiments, at least a portion of the cover 1300 may comprise crystals to allow for crystal therapy in combination with the weighted comfort.

In some aspects, the weighted material may be removable from the cover 1300. In some embodiments, the cover 1300 may comprise a mechanism that allows removal of weighted material. For example, the cover 1300 may comprise a zipper mechanism on the end of the device, a hook and loop system may be put in place to seal the material inside, as a non-limiting example.

In some implementations, the cover 1300 may only be weighted on the topside and the sides may comprise a different material 1350. In some aspects, the ends of the cover 1300 may comprise weighted ends that secure the cover 1300 as a blanket for the user, limiting movement of the cover 1300 as a user shifts. In some implementations, the cover 1300 may comprise tags indicating the sections that may be weighted. In some aspects, the cover 1300 may comprise one or more materials 1350 at a time.

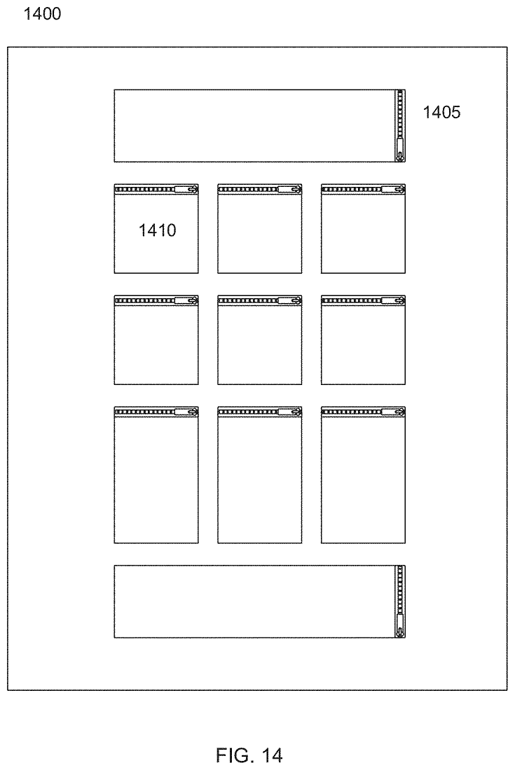

Referring now to FIG. 14, an exemplary cover 1400 comprising a plurality of pockets 1410 and securing mechanisms 1405 is illustrated. In some embodiments, the cover 1400 may comprise a plurality of pockets 1410 throughout its surface area. In some aspects, each pocket 1410 may comprise a securing mechanism 1405. In some implementations, the securing mechanisms 1405 may comprise a zipper, hook and eye loop system, or tabbing, as non-limiting examples that may seal items inside the pocket 1410.

In some implementations, the pockets 1410 may be removed and placed on other regions of the cover 1400. In some aspects, the cover 1400 may comprise a plurality of crystal pockets 1410, wherein each of the plurality of crystal pockets 1410 is configured to hold at least a portion of the plurality of crystals. As an illustrative example, one or more pockets may contain weights of predetermined size. The longer weighted pockets may be aligned along the perimeter of the blanket for stability. Smaller, cubic weighted pockets may be positioned in the center of the blanket to provide a weighed sensation for a child temporarily using an adult blanket.

In some embodiments, the pockets 1410 on the cover 1400 may comprise a different material. For example the cover 1400 may comprise a cotton-like material and the pockets 1410 may comprise a polyester material. In some embodiments, the pockets 1410 and the securing mechanisms 1405 may exist on both sides of the cover 1400. In some implementations, a crystal pocket 1410 may comprise at least one of a plurality of crystals, wherein the crystal pocket 1410 is located on the first layer. In some aspects, an interior flap may be proximate to the crystal pocket 1410, wherein the interior flap secures a plurality of crystals within the crystal pocket 1410. In some aspects, the pockets 1410 may exist on either side of the cover 1400.

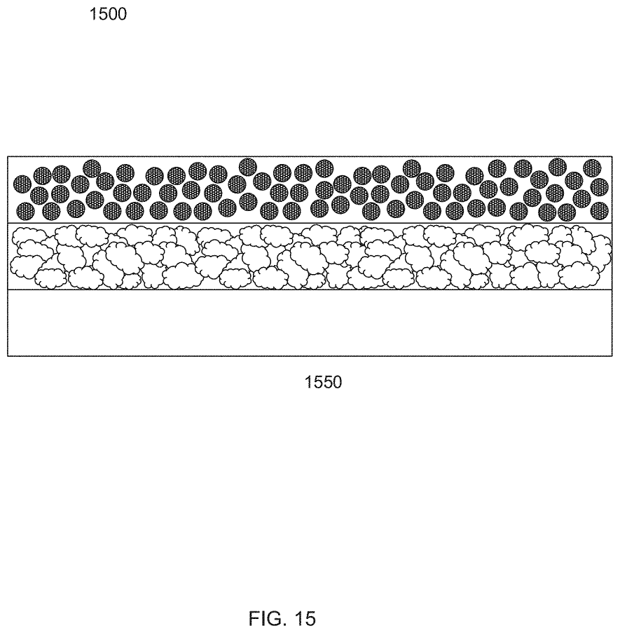

Referring now to FIG. 15, a crystal therapy device 1500 that comprises multiple layers of different materials 1550 is illustrated. In some aspects, the material 1550 may not be limited to a specific layer of the crystal therapy device 1500. In some implementations, the top layer may comprise a weighted material 1550 that may include crystal. In some aspects, the middle layer may comprise a temperature regulation material 1550. For example, the middle layer may comprise a cooling layer. In some embodiments, the bottom layer may comprise a cotton-like material 1550 as a non-limiting example.

In some embodiments, the layers of the crystal therapy device 1500 may be interchangeable for user comfort. For example, the cotton-like bottom layer may interchange with the top layer of the weighted material 1550. In some embodiments, the exterior of the crystal therapy device 1500 may comprise the same material to enclose the interior layers. In some implementations, the different layers of the crystal therapy device 1500 may be separated so that the retained material 1550 does not mix.

In some implementations, a crystal therapy device 1500 may comprise at least one weighted portion configured to hold weighted material 1550. In some aspects, a crystal therapy device 1500 may comprise a cover portion comprising a first layer and a second layer. In some implementations, the crystal therapy device 1500 may comprise filler material 1550 located between the first layer and the second layer, wherein the filler material 1550 is configured to provide shape to the cover portion.

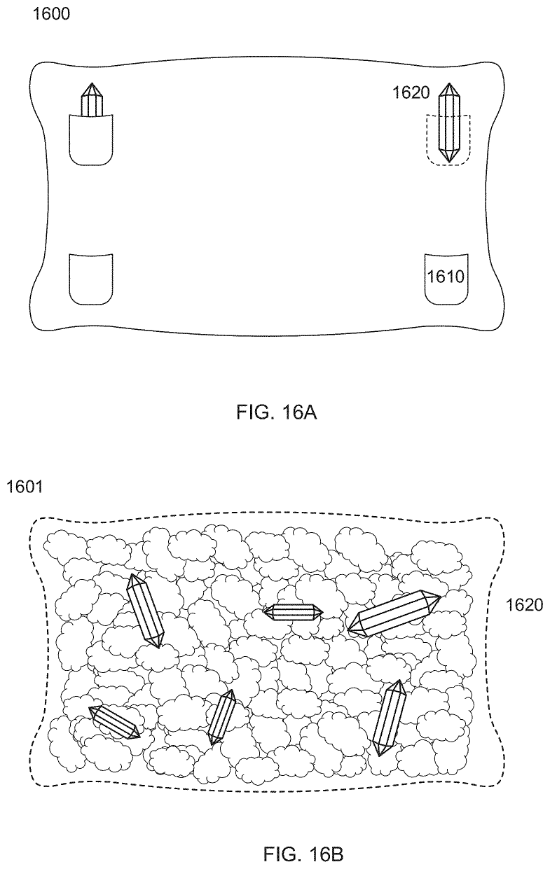

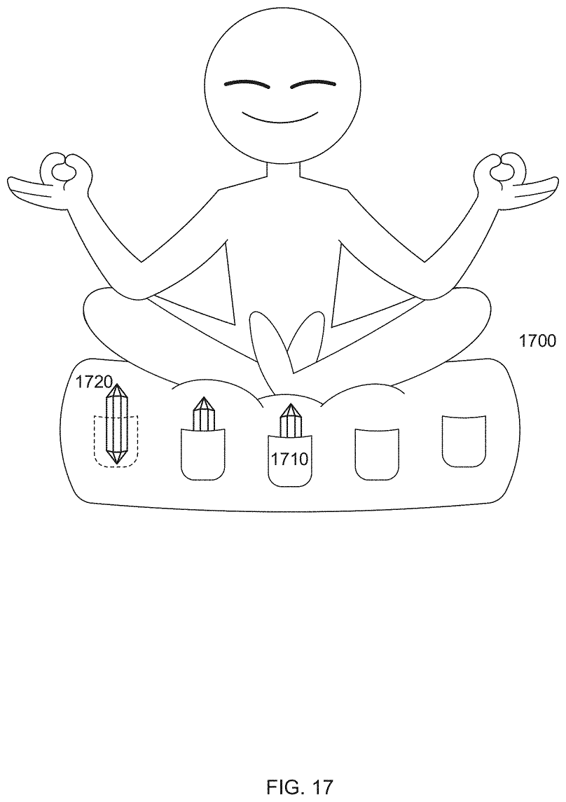

Referring now to FIG. 16A, a cover 1600 comprising a plurality of pockets 1610 is illustrated. In some embodiments, the cover 1600 may be used as a covering fora pillow. In some aspects, the pockets 1610 may be on the exterior of the cover 1600. In some implementations, the cover 1600 may be reversable and pockets 1610 may exist on either side of the device. In some aspects, crystals 1620 may be placed inside the pockets 1610 to be used therapeutically while the cover 1600 is in use.

In some embodiments, the pockets 1610 may comprise different securing mechanisms to retain the crystal 1620 during use. For example, the pockets 1610 may comprise a flap with a hook and loop attachment to secure the crystals 1620. In some embodiments, the pockets 1610 may be directly connected to the cover 1600. For example, the out seams of the pocket 1610 may be sown directly onto the base of the pillow 1600. In some aspects, the pillow 1600 may comprise extra material around the pockets 1610 to provide for extra cushioning where the crystals 1620 may extrude from the pockets 1610.

Referring now to FIG. 16B, a cover 1601 comprising a plurality of crystals 1620 is illustrated. In some embodiments, the interior of the cover 1601 may comprise a plurality of crystals 1620. In some aspects, crystals 1620 may be scattered at random throughout the interior of the cover 1601.

In some embodiments, the cover 1601 may have material embedded on the interior that both protects the crystal 1620 from damage and keep the user safe from possible injury by extruded crystals 1620. In some implementations the cover 1601 may comprise a mechanism that allows crystals 1620 to be inserted and removed at will. For example, the cover 1601 may have a zipper mechanism that goes around the edge of the exterior to open and secure the cover 1601.

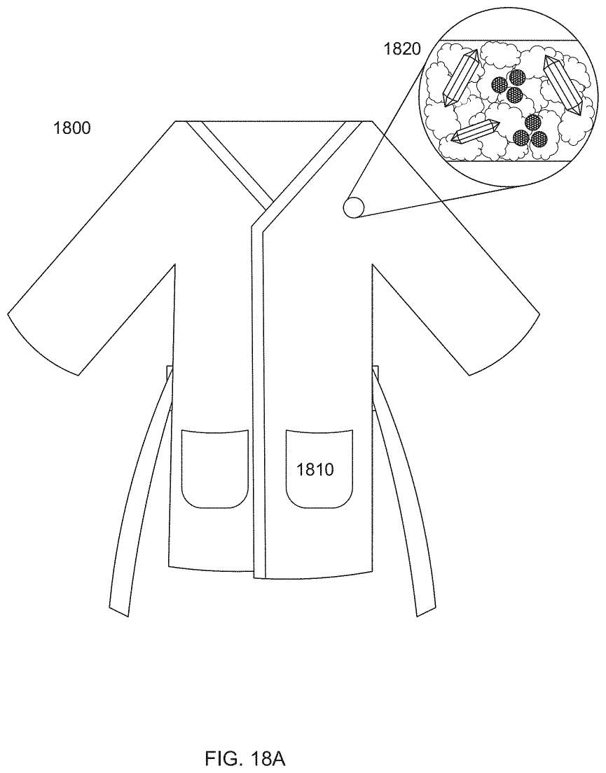

Referring now to FIG. 17, an exemplary pillow 1700 comprising a plurality of pockets 1710 is illustrated. In some implementations, the pillow 1700 may allow the user to sit atop the pillow 1700. In some embodiments, the pillow 1700 may allow items to be stored within the pillow 1700. For example, the interior of a meditation pillow may comprise a small cavity in the center of the padding to place a crystal 1720. The internal cavity may alternatively be used as a small storage location.

In some aspects, the pockets 1710 may be located on the peripheral edge of the exterior of the pillow 1700. In some aspects, the pillow 1700 may comprise a plurality of crystal pockets 1710, wherein each of the plurality of crystal pockets 1710 is configured to hold at least a portion of the plurality of crystals. In some embodiments, the pockets 1710 may be interchangeable across the exterior of the pillow 1700. For example, one pocket 1710 may be removed and placed into another spot on the exterior the pillow 1700.

In some embodiments, the pillow 1700 may comprise an external form on the top of the device that allows for a user to sit comfortably. In some implementations, the top of the pillow 1700 may comprise a different material than the other parts of the device. In some implementations, crystals 1720 and other items may be placed into the pockets 1710, including for example, amulets, written material, or stowable objects. In some embodiments, the pockets 1710 may comprise different sizes. In some aspects, more than one crystal 1720 may be placed into the same pocket 1710 at a time. In some aspects, the pillow 1700 may comprise a flap that covers the outer area where the pockets 1710 exist. For example, the flap may be folded over the pockets 1710 to protect the contents on the inside.

In some aspects, the pockets 1710 may be used to hold shoes, jewelry, food, and other non-limiting examples. In some aspects, each pocket 1710 may have an individual flap that covers the contents in one particular pocket. For example, a crystal 1720 may be placed into the pocket 1710 and a flap may then fold over and secure the contents inside from being damaged or falling out.

In some embodiments, the pillow 1700 may be rolled up for travelling purposes. In some aspects, the material on the inside of the pillow 1700 may be taken out for the device to be compacted easier. In some implementations, the pillow 1700 may be inflatable. For example, a travel friendly meditation pillow may compress for transport and then be inflated for use upon arrival to a predetermined destination.

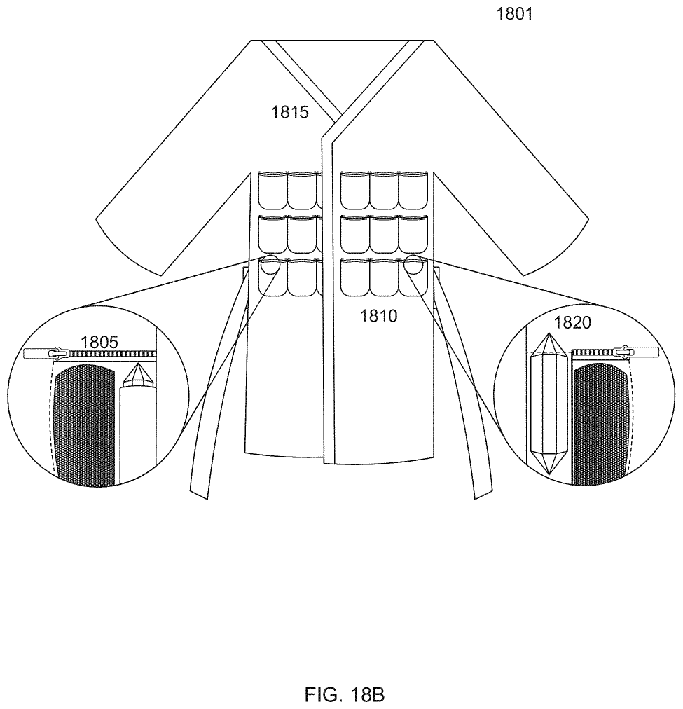

Referring now to FIG. 18A, illustrates an exemplary crystal retention device 1800 comprising a plurality of pockets 1810. In some embodiments, the robe 1800 may comprise a crystal composite material. In some implementations, the pockets 1810 may be used for storing items. In some aspects, the robe 1800 may be used as a robe like article of clothing. In some embodiments, the robe 1800 may be weighted. In some aspects, the robe 1800 may have crystals 1820 lined on the interior of the device. For example, the crystals 1820 may be smaller and combined within the embedded material of the robe 1800.

In some implementations, the pockets 1810 may comprise a plurality of crystals 1820. In some aspects, the pockets 1810 may comprise a plurality of sizes. In some embodiments, the pockets 1810 may provide utility for a plurality of functions. In some implementations, a crystal pocket 1810 may comprise at least one of a plurality of crystals 1820, wherein the crystal pocket 1810 is located on the first layer. In some aspects, an interior flap may be proximate to the crystal pocket 1810, wherein the interior flap secures a plurality of crystals within the crystal pocket 1810. In some implementations, the pockets 1810 may be used to access the inner lining of the robe 1800. For example, the pockets 1810 may be opened to gain access to the interior material the robe 1800 is comprised of. In some aspects, the crystals 1820 on the interior may be changed out using the access from the pockets 1810.

Referring now to FIG. 18B, an exemplary robe 1801 that may comprise crystal-like material and pockets 1810 with securing mechanisms 1805 is illustrated. In some embodiments, the securing mechanism 1805 may be used to keep the contents inside the pocket 1810 safe from damage and other possible exposure. In some aspects, the securing mechanism 1805 may be used to help keep the pocket adhered to the robe 1801. In some embodiments, the robe 1800 may contain a non-limiting number of pockets 1810 throughout the device. In some implementations, the robe 1800 may comprise multi-layered pockets 1810. In some aspects, pockets 1810 may comprise pockets 1810. In some embodiments, a plurality of embedded pockets may be secured by a securing mechanism 1805.

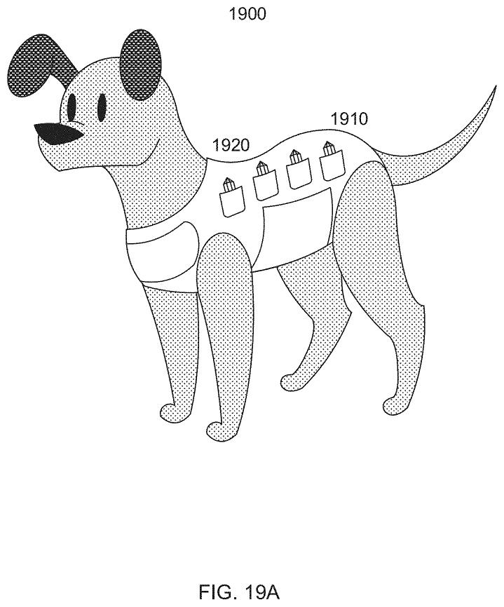

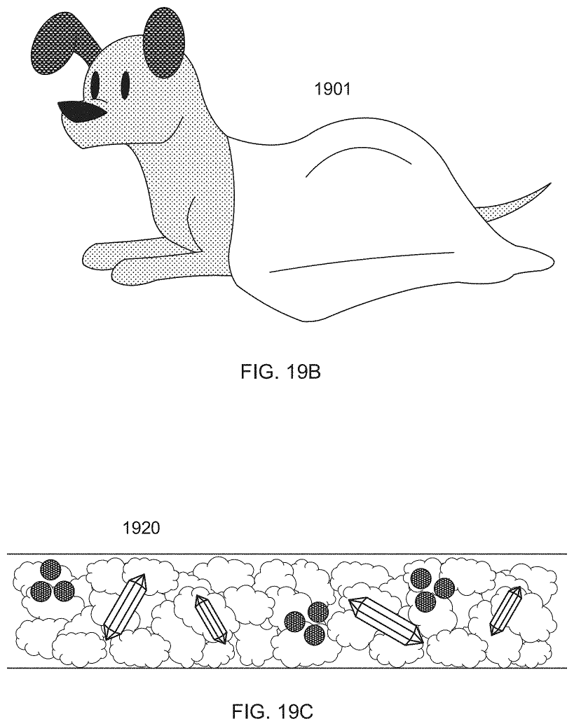

Referring now FIG. 19A, an exemplary pet vest 1900 comprising a plurality of pockets 1910 is illustrated. In some embodiments, the pet vest 1900 may be used for animals, such as for comfort or physical support. In some aspects, the pet vest 1900 may have pockets 1910 lined along the outside of the device. In some implementations, the pockets 1910 may comprise crystals 1920. In some aspects, the pockets 1910 may comprise one or more crystals 1920 at a time.

Referring now to FIG. 19B, an exemplary cover 1901 is illustrated. In some embodiments, the cover 1901 may be used a cover for animals. In some aspects, the cover 1901 may come in different sized surface areas for different sized, and types of animals. In some aspects, the cover 1901 may comprise a shed-free material that catches animal hair. For example, the cover 1901 may have a material that allows all stray animal hairs to stick to the material. In some aspects, the cover 1901 may be machine washable. In some embodiments, the cover 1901 may comprise a weighted material, which may add to the comfort of the pet.

In some embodiments, a cover 1901 may comprise at least one crystal pockets configured to hold at least a portion of the plurality of crystals. In some aspects, the cover 1900 may comprise a plurality of crystal pockets, wherein each of the plurality of crystal pockets is configured to hold at least a portion of the plurality of crystals. In some implementations, a cover 1901 may comprise at least one weighted portion configured to hold weighted material. In some aspects, a cover 1901 may comprise a cover portion comprising a first layer and a second layer. In some implementations, the cover 1901 may comprise filler material located between the first layer and the second layer, wherein the filler material is configured to provide shape to the cover 1901 portion.

Referring now to FIG. 19C, an exemplary material 1950 comprising crystals 1920 is illustrated. In some embodiments, the material 1950 may be infused with small crystals 1920. In some implementations, other miniscule items that help with therapy, meditation and other non-limiting examples may be included as well. In some embodiments, the material 1950 may comprise a composite of substances. In some implementations, different crystals 1920 may be used for different reason when infused into the device. For example, an amethyst may be used for different purposes than an opal might be used. In some aspects, a plurality of different crystals 1920 may reside within the material 1950.

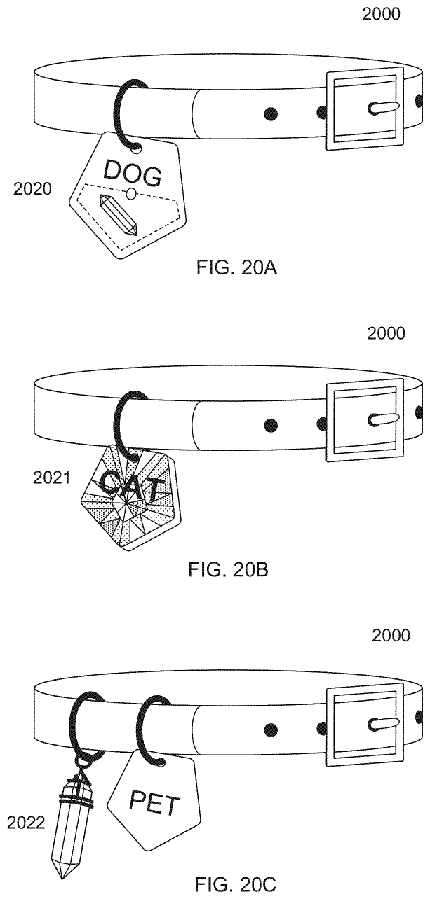

Referring now FIG. 20A, an exemplary collar 2000 is illustrated. In some implementations, the collar 2000 may be used to as a collar. In some aspects, the collar 2000 may come in different sizes. In some embodiments, the collar 2000 may have a plurality of crystals 2020 infused on the interior of a larger object.

For example, a smaller size collar 2000 may have five crystals 2020, whereas a larger size collar 2000 may have twelve crystals 2020. In some aspects, the collar 2000 may comprise a custom name tag that hangs from underneath the device. In some embodiments, the collar 2000 may attachment to an external object. For example, a single side adhesive pocket containing a crystal 2020 may attach to the back of an existing dog tag.

Referring now to FIG. 20B, an exemplary collar 2000 is illustrated. In some embodiments, the collar 2000 may be used to as a collar. In some implementations, a crystal 2021 may be used as the custom name tag. For example, a crystal 2021 may be engraved on and then hung from a dog collar. In some aspects, the collar 2000 may have holes along the device that allow for it to be adjustable. In some embodiments, the collar 2000 may comprise more than one material 2050.

Referring now to FIG. 20C, an exemplary collar 2000 is illustrated. In some aspects, the collar 2000 may provide attachments for additional items. In some embodiments, a crystal 2022 may hang from underneath the collar 2000. In some implementations, the crystal 2022 and additional objects may hang from the same fixed position. In some implementations, the crystal 2022 and additional objects may hang from a plurality of predetermined locations on the collar 2000. In some aspects, the crystal 2022 may be removable. In some aspects, the additional objects may be removable.

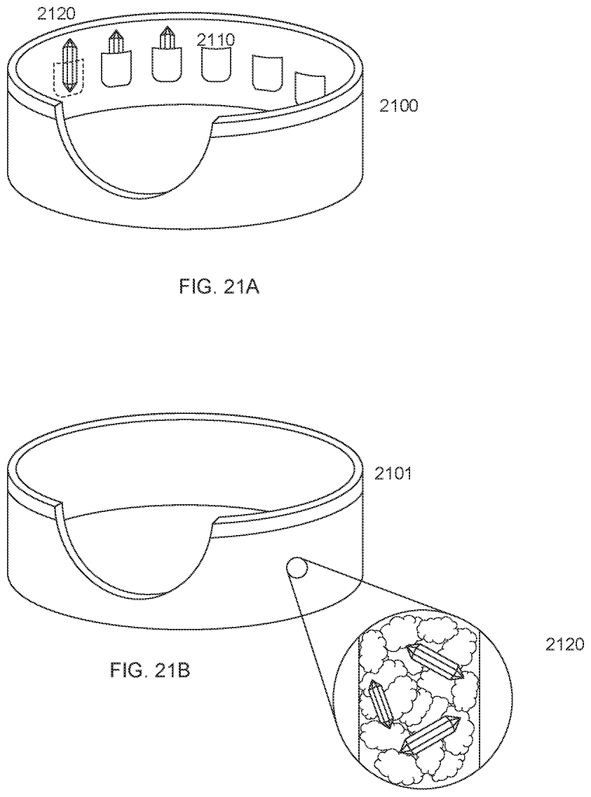

Referring now to FIG. 21A, an exemplary pet bed 2100 is illustrated. In some embodiments, the pet bed 2100 may be used as an animal bed. In some aspects, the pet bed 2100 may comprise pockets 2110 on the interior of the device. In some aspects, the pockets 2110 may be used to enclose crystals 2120 within the pet bed 2100. In some embodiments, the pet bed 2100 may have an opening along the frontside that allows an animal to enter the pet bed 2100. In some implementations, the pockets 2110 may comprise flaps that fit over the top of the pockets 2110 to keep the contents inside hidden from the animal. For example, the flap may come over the pocket 2110 that has a crystal 2120 inside to prevent an animal from ingesting the crystal 2120.

In some aspects, the pet bed 2100 may comprise one or more materials throughout the interior of the pet bed 2100. In some embodiments, the pockets 2110 may comprise a mechanism that allows them to be removed and place elsewhere on the pet bed 2100. For example, the back of a pocket 2110 may have a clip that slides into the material of the pet bed 2100 and may easily be removed and slid into another section of the device. In some implementations, the pet bed 2100 may comprise a cooling material that activates when an animal is present on the material.

Referring now to FIG. 21B, an exemplary pet bed 2101 that may be used as an animal bed that may comprise crystal 2120 mixed material is illustrated. In some embodiments, the pet bed 2101 may be lined with crystals 2120 on the inside of the device. In some aspects, the crystals 2120 may help with pet therapy, similar to the use for humans. In some implementations, more than one type of crystal 2120 may be mixed into the material of the pet bed 2101. For example, a quartz and topaz may both be integrated into the material or lining of the pet bed 2101. In some aspects, different types of crystals 2120 may serve different purposes when being used for therapeutics.

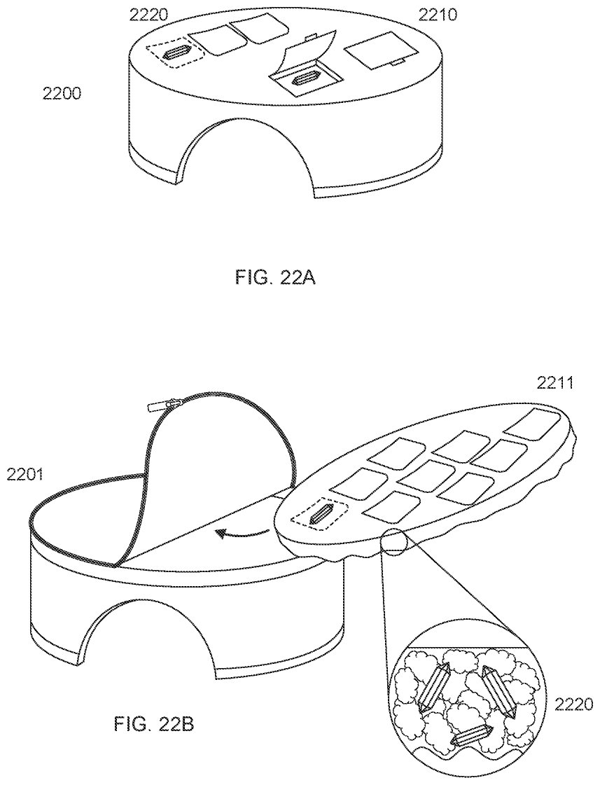

Referring now to FIG. 22A, the underside of the pet bed 2200 may comprise pockets 2210 to hold crystals 2220 for crystal therapy. In some aspects, this may keep crystals 2220 safe from being damaged or ingested by animals. In some implementations, a crystal pocket 2210 may comprise at least one of a plurality of crystals 2220, wherein the crystal pocket 2210 is located on the first layer. In some aspects, an interior flap may be proximate to the crystal pocket 2210, wherein the interior flap secures a plurality of crystals 2220 within the crystal pocket 2210. In some embodiments, the pockets 2210 may comprise flaps that secure the contents. In some implementations, the number and size of the pockets may depend on preference, size of the pet bed 2200, size of the pet, or size of the crystals 2220, as non-limiting examples.

Referring now to FIG. 22B, a pet bed 2201 comprising pockets 2211 for containing crystals 2220 is illustrated. In some implementations, a base with pockets 2211 may be inserted into a sleeve or lining of a pet bed 2201. In some embodiments, an insert may prevent a pet from accessing or swallowing the crystals 2220. The insert may comprise a padded material with small crystals integrated throughout. In some aspects, pockets 2211 may allow for the addition of selected crystals in addition to those incorporated into the padded material of the insert.

### CONCLUSION

A number of embodiments of the present disclosure have been described. While this specification contains many specific implementation details, these should not be construed as limitations on the scope of any disclosures or of what may be claimed, but rather as descriptions of features specific to particular embodiments of the present disclosure.

Certain features that are described in this specification in the context of separate embodiments can also be implemented in combination or in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

What is claimed is:

1. A wearable crystal therapy mask comprising:
a plurality of crystals; and
a mask configured to cover eyes of a user when worn, wherein the mask comprises:
a first layer,
a crystal pocket containing at least one of the plurality of crystals, wherein the crystal pocket is located on the first layer,
an interior flap proximate to the crystal pocket, wherein the interior flap secures the at least one of the plurality of crystals within the crystal pocket, and
a securing mechanism configured to secure the mask to the user.

2. The wearable crystal therapy mask of claim 1, wherein the plurality of crystals are interchangeable.

3. The wearable crystal therapy mask of claim 1, wherein the crystal pocket is embedded within the first layer.

4. The wearable crystal therapy mask of claim 1, wherein the mask further comprises a second layer and the crystal pocket is located between the first layer and the second layer.

5. The wearable crystal therapy mask of claim 4, wherein the crystal pocket is removable.

6. The wearable crystal therapy mask of claim 4, wherein the first layer and the second layer form a weighted pocket that holds weighting material.

7. The wearable crystal therapy mask of claim 6, wherein the weight of the weighted pocket is customizable.

8. The wearable crystal therapy mask of claim 6, wherein the at least one of the plurality of crystals is mixed with the weighting material.

9. The wearable crystal therapy mask of claim 8, wherein the at least one of plurality of crystals and weighting material is further combined with a filler material.

10. The wearable crystal therapy mask of claim 8, wherein the plurality of crystals comprise crystal particles.

11. A crystal therapy cover comprising:
a plurality of crystals;
at least one crystal pocket configured to hold at least a portion of the plurality of crystals;
at least one weighted portion configured to hold weighted material;
a cover portion comprising a first layer and a second layer; and
filler material located between the first layer and the second layer, wherein the filler material is configured to provide shape to the cover portion.

12. The crystal therapy cover of claim 11, wherein the plurality of crystals comprise a plurality of types of crystals.

13. The crystal therapy cover of claim 11, wherein the first layer and the second layer comprise a series of filler pockets, wherein each of the series of filler pockets comprises a pocket segment with filler material.

14. The crystal therapy cover of claim 13, wherein at least a portion of the series of filler pockets comprises mixed pockets comprising filler material and one or both at least one crystal pocket and at least one weighted portion.

15. The crystal therapy cover of claim 14, wherein at least a filler portion of series of filler pockets only contain filler material, and wherein the mixed pockets are located centrally on the crystal therapy cover and the filler portion is located along a perimeter of the crystal therapy cover.

16. A crystal therapy cover comprising:
a plurality of crystals;
a plurality of crystal pockets, wherein each of the plurality of crystal pockets is configured to hold at least a portion of the plurality of crystals;
a plurality of weighted pockets configured to hold weighted material;
a cover portion comprising a first layer and a second layer; and
filler material located between the first layer and the second layer, wherein the filler material is configured to provide shape to the cover portion.

17. The crystal therapy cover of claim 16, wherein at least a portion of the plurality of crystal pockets are located within a portion of the plurality of weighted pockets, wherein the at least a portion of the plurality of crystals and the weighted material are separate.

18. The crystal therapy cover of claim 16, wherein the plurality of crystal pockets align with chakras of a user when the cover is used.

19. The crystal therapy cover of claim 16, wherein at least a portion of the plurality of crystal pockets and a portion of the plurality of weighted pockets are combined, wherein the at least a portion of the plurality of crystals and the weighted material are mixed.

20. The crystal therapy cover of claim 19, wherein the at least a portion of the plurality of crystals and the weighted material are further mixed with filler.
